(19) United States
(12) Patent Application Publication
(10) Pub. No.: US 2014/0089075 A1
(43) Pub. Date: Mar. 27, 2014

(54) VIRTUAL QUEUE MANAGEMENT SYSTEM

(71) Applicant: Queue Technologies, Inc., San Francisco, CA (US)

(72) Inventors: Joseph SANCHIS, San Francisco, CA (US); Javier Chretian MUNIZ, Reno, NV (US)

(73) Assignee: Queue Technologies, Inc., San Francisco, CA (US)

(21) Appl. No.: 14/038,568

(22) Filed: Sep. 26, 2013

Related U.S. Application Data
(60) Provisional application No. 61/705,750, filed on Sep. 26, 2012.

(51) Int. Cl. G06Q 30/02

(52) U.S. Cl. CPC G06Q 30/0226
USPC 705/14.27

(57) ABSTRACT

Disclosed is a system which provides virtual queue management services, which services are customized through a website and/or API, which services allow the managed virtual queues to be dynamically re-ordered based on queue participant behavior, which services may allow queue participants to see the relative or absolute position of other queue participants in a virtual queue, and which services enable virtual queue interaction via mobile and non-mobile computing devices, whether onsite or remote from a queue location.

### BACKGROUND INFORMATION

Traditionally, people wait in lines or queues to receive goods and services and for other purposes. In traditional contexts, queues generally exist when there is scarcity with respect to the good or service (with the good or service going to those early in the queue, such as people lining up for movie tickets or better seats in the house) or there is a bottleneck with respect to accessing or distributing the good or service (such as a phone queue to access customer support). Traditional queues are generally first-in-first-out or first-in-last-out and re-ordering a tradition queue (“cutting the line”) involves social friction. Systems to reward queue-participant behavior by re-ordering the queue or providing other consideration simply have not been widely contemplated.

Digital electronic communication has opened up new concepts of “lines,” often with many different issues than were encountered in traditional queue contexts. Existing queues in electronic communication contexts, however, still often follow the traditional chronological ordering approach and have not fully explored the potential to interact with the queue participants. Queues in electronic communication contexts are also often implemented piecemeal by the party controlling the good or service to be allocated; queue management services are not provided as a service to the parties controlling the goods or services to be allocated. This piecemeal approach reduces the resources available to design complex queues and limits the exploration of alternatives to traditional queue paradigms.

Needed is a system which allows queue management to be provided as a service and which allows non-traditional queue ordering rules to be designed and implemented.

### SUMMARY

Disclosed is a system which provides virtual queue management services, which services are customized through a website and/or API, which services allow the managed virtual queues to be dynamically re-ordered based on queue participant behavior, which services may allow queue participants to see the relative or absolute position of other queue participants in a virtual queue, and which services enable virtual queue interaction via mobile and non-mobile computing devices, whether onsite or remote from a queue location.

### BRIEF DESCRIPTION OF THE DRAWINGS

FIG. 1 is network and device diagram illustrating exemplary computing devices configured according to embodiments disclosed in this paper.

FIG. 2 is a flowchart illustrating a process in which a party obtains and customizes queue management services through a system according to embodiments disclosed in this paper.

FIG. 3 is a flowchart illustrating a process in which a queue is managed by the queue management service system according to embodiments disclosed in this paper.

FIG. 4 is a flowchart illustrating details of alternative embodiments for a portion of the flowchart illustrated in FIG. 3.

FIG. 5 is a flowchart illustrating a process in which a queue participant interacts with the queue management service system according to embodiments disclosed in this paper.

FIG. 6 is a flowchart illustrating a process in which a queue participant interacts with the queue management service system via a mobile device according to embodiments disclosed in this paper.

FIG. 7 is a functional block diagram of exemplary computing devices and some data structures and/or components thereof.

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words in the singular may also include the plural while words using the plural may also include the singular. The word “or,” in reference to a list of two or more items, covers all of the following interpretations of the word: any of the items in the list, all of the items in the list, and any combination of one or more of the items in the list.

As used herein, the party controlling a good or service to be allocated shall be referred to as a “queue service customer” or “customer.” The party providing the queue services to the queue service customer shall be referred to as a “queue service provider” or “provider.” The queue participant shall be referred to as the “end user.”

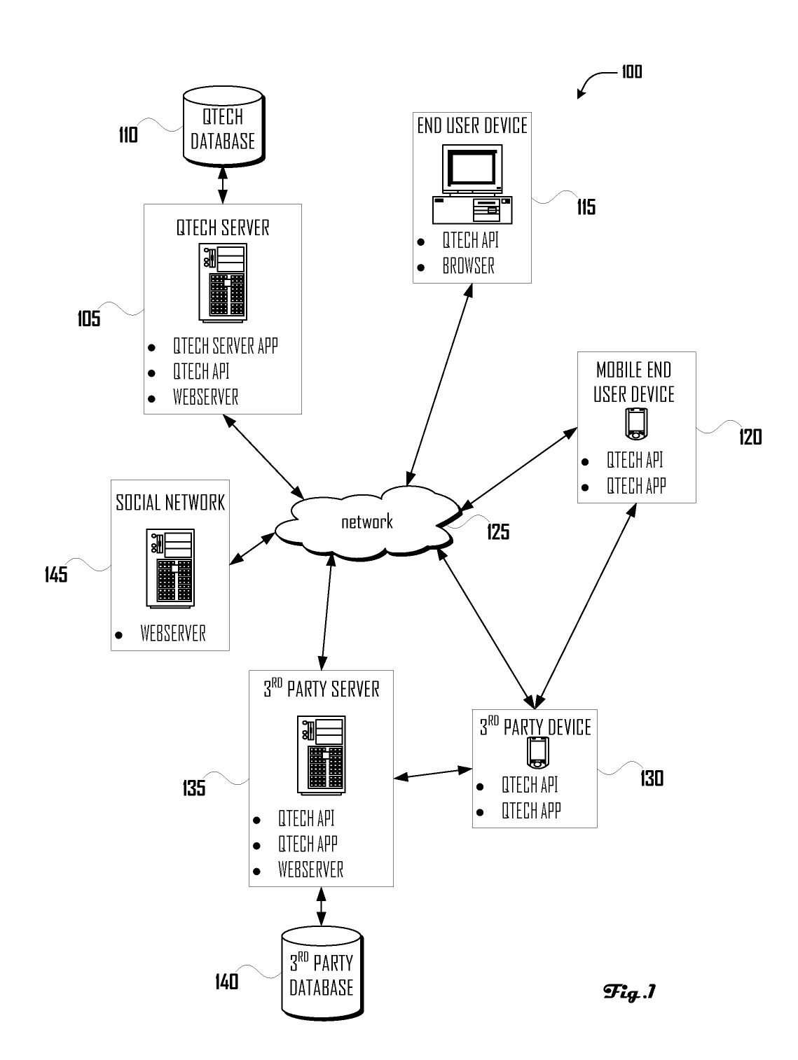

FIG. 1 is network and device diagram illustrating exemplary computing devices configured according to embodiments disclosed in this paper. As illustrated, a Qtech Server 105, operated by the provider, is connected to a network 125, such as the Internet. The Qtech Server 105 is illustrated as comprising a software routine for the Qtech Server Application (or “Qtech Server App”), a webserver, as well as the Qtech API. As an “API” or application programming interface, the Qtech API may be considered to be part of the Qtech Server Application; the Qtech API provides objects (generally subroutines), parameters for the objects, ways to use the objects, and ways to communicate with objects in applications (software routines) which use the API in various of the devices. As illustrated, some or all of the Qtech API may be found in the Qtech Server Application, in the Qtech Apps in the 3^{rd} Party Device 130, in the 3^{rd} Party Server 135, in the End User Device 115, and/or in the Mobile End User Device 120.

Also connected to the network 125 are a 3^{rd} Party Server 135 and a 3^{rd} Party Device 130. The 3^{rd} Party Server 135 is illustrated as comprising software routines for a webserver and (optionally) software routine for a Qtech App and (optionally) components of the Qtech API. The 3^{rd} Party Server 135 may be operated by a customer or by another 3^{rd} party, such as, for example, a point-of-sale system operator. As discussed herein, the 3^{rd} Party Server 135 and the 3^{rd} Party Device 130 may obtain queue services from the Qtech Server 105 and may interact with end users. The queue services may be provided to end users through website-based queues (served by the 3^{rd} Party Server 135 or by the Qtech Server 105) or through Qtech App-based queues, all of which queues shall be referred to herein as “Qtech Queues.”

Also connected to the network 125 are an End User Device 115 and a Mobile End User Device 120. The End User Device 115 is illustrated as containing a routine for a browser while the Mobile End User Device 120 is illustrated as containing a routine for a Qtech App. Not shown, the End User Device 115 may also contain a routine for a Qtech App and the Mobile End User Device 120 may also contain a routine for a browser. End users may use these end user devices to participate in Qtech Queues and to interact with the Qtech Server 105.

Also connected to the network 125 is a Social Network 145, representing social networks such as FACEBOOK®, TWITTER, GOOGLE+, and similar. The Social Network 145 is illustrated as comprising a routine for a webserver, to serve a webpage (or similar mobile device applications) comprising the social network services.

As discussed further herein, the Qtech Server 105 provides queue services to customers who use the services to create and manage queues (also referred to herein as “virtual queues”). The customers configure the queue services via a website (or similar) interface served by the Qtech Server 105 webserver or via the Qtech API. As an example, the Qtech Server 105 may serve a website for a Qtech Queue, for example, a queue for purchasing a new type of mobile device (such as when the mobile device is released). As discussed further herein, the queue services may provide that certain actions by end users, whether at End User Device 115, Mobile End User Device 120, or 3^{rd} Party Device 130, are logged in separate log files for individual end users. Examples of actions include entering the Qtech Queue, “liking” a product or a company in a social network, including a specified hashtag in a communication (for example, in a TWEET), sending a positive free-text message about the product or company in a social network, or contacting a 3^{rd} Party Device 130 (such as by going to a venue and inputting an identifier for the end user, such as by typing or otherwise inputting an identifier into the 3^{rd} Party Device 130, having the 3^{rd} Party Device 130 take a picture of the end user (which picture is processed to identify the end user), or by becoming physically close to the 3^{rd} Party Device 130 such that a Mobile End User Device 120 (with or without participation of a Qtech App being executed by the Mobile End User Device 120) may communicate directly with the 3^{rd} Party Device 130 and/or the 3^{rd} Party Server 135. These actions may also be referred to as “Attributes” of a Qtech Queue. The period of time when end users are in a Qtech Queue may be referred to as the “Champaign” period of a Qtech Queue.

As discussed further herein, the end user log files may be processed and “queue scores” determined. The queue score is determined based on the configuration of the Qtech Server 105, which may be a default or a customized configuration (discussed further herein), which configuration assigns “points” to the different actions. The queue scores for all of the end users in the queue are determined and ranked; optionally, as the Qtech Queue is proceeding, one or more of the end users can see the queue score, rank, and/or actions of themselves and/or other end users. In this way, end users may be allowed to see dynamic advancement through the Qtech Queue. During or at the conclusion of the Qtech Queue (which may be based, for example, on a time, a bidding price threshold, the occurrence of a number of end user actions, or a number of end users in the queue), the queue score rank of the end users may be used to award, sell, or otherwise provide the goods or services or to provide incentives along the way.

The Qtech Server 105 and 3^{rd} Party Server 135 are illustrated as being connected to databases (the Qtech Database 110 and the 3^{rd} Party Database 140). This paper discusses components as connecting to the Qtech Server 105 or to the 3^{rd} Party Server 135 or to a database connected to one of such servers; it should be understood that such connections may be to, through, or via the other of the two connected components (a statement that a computing device connects with or sends data to the Qtech Server 105 should be understood as saying that the computing device may connect with or send data to the Qtech Server 105 and/or the Qtech Database 110). Although illustrated as separate components, the servers and databases may be provided by common (or separate) physical hardware and common (or separate) logic processors and memory components.

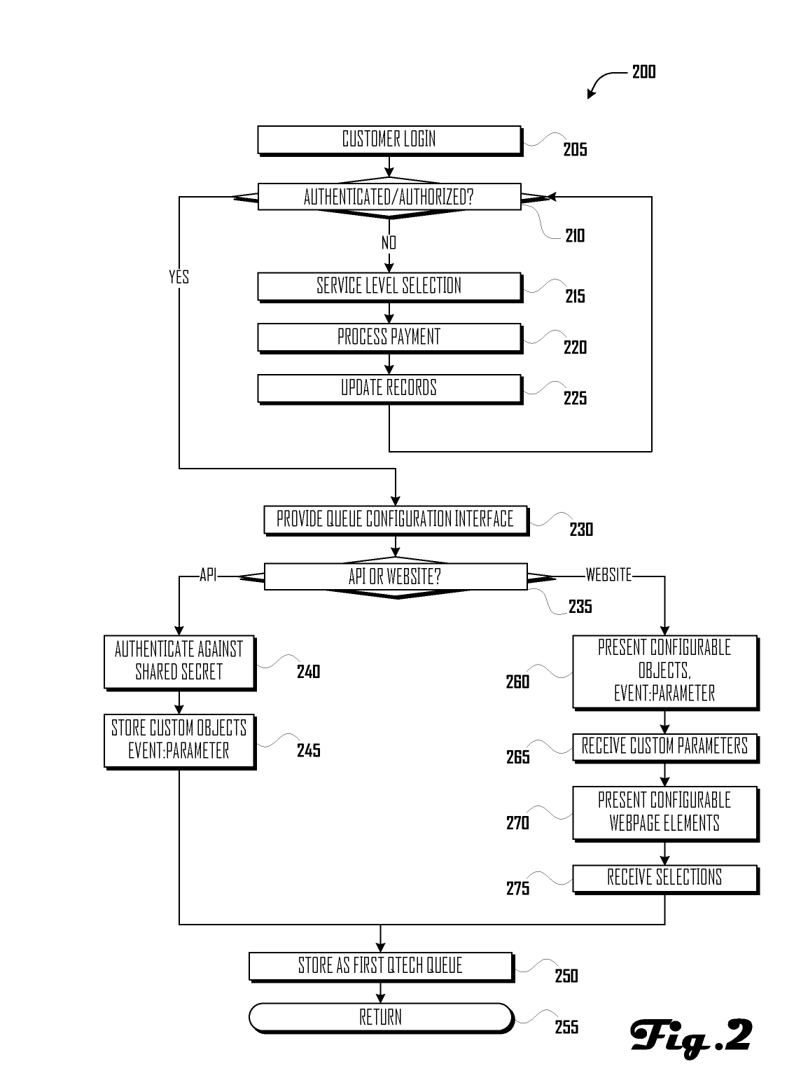

FIG. 2 is a flowchart illustrating a process in which a customer obtains and customizes queue management services through a system according to embodiments disclosed in this paper. At step 205, the customer logs into, for example, the Qtech Server 105. At step 210, a determination may be made regarding whether the customer is authenticated and authorized (authorization may be necessary if there are different levels of queue management services being offered). If the customer is not authenticated and/or authorized, then at step 215 the customer may optionally select a service level. At step 220 payment information may be received and processed. At step 225, records associated with the customer may be updated to reflect the successful service level selection and payment. Following step 225, the process may optionally proceed back to step 210 or may then proceed to step 230. The process may proceed to step 230 if the customer was authenticated and/or authorized at step 210.

At step 230, the Qtech Server 105 provides the queue configuration interface which may be used to configure functions which define a Qtech Queue (to establish the Attributes of the Qtech Queue). The queue configuration interface may be, for example, a website where configuration choices may be input or the configuration interface may be via the Qtech API, in which case the configuration interface may comprise establishing a secure connection between the Qtech Server 105 and the device configuring the Qtech Server 105. A secure connection may be provided, for example, by use of a certificate, a “shared secret,” authentication token, or technique which may be used to encrypt and/or authenticate and authorize API commands. The choice in queue configuration interfaces is illustrated as decision step 235. If the API is the configuration interface, then at step 240, API commands and acknowledgments may be sent/received and authenticated at one or both of the Qtech Server 105 and the device which is issuing the API commands (which may be the 3^{rd} Party Server 135 and/or a 3^{rd} Party Device 130), for example, using a shared secret or a certificate. At step 245, customized objects configured by the API commands may be stored, such as in the Qtech database 110. The customized objects are represented at step 245 as “event:parameter” objects, though other object types may exist, this is an example. For example, an event:parameter object may define an event, such as a social network “like” and points to be given for the “like” (more than one parameter may be provided for an object, this is an example), which together form a function defining an Attribute of the Qtech Queue. The “event:parameter” object is an example; other objects may allow the customer to upload a graphic, text, or similar, which graphic will be presented to end users. Generic objects may be referred to herein as “object:parameter” sets. As an example, the API command may comprise an “activity_type” object:parameter set (see discussion, below, relating to the Qtech log at step 350). The activity_type may be configured according to a range of parameters created by the provider (such as that a “like” earns one to five points) or the activity_type may be custom defined by the customer. Different activity_type objects may interact (such as, for example, that checking in to all venues of a particular type in a geographic area earns points in addition to points earned for checking in to the individual venues in the geographic area). At step 250, if not part of step 245 or 265, the configured Qtech Queue is stored as a first Qtech Queue. At step 255 the process is done or returns, for example by logging out the customer or by returning to step 230.

If the configuration interface at step 235 is a website, then the Qtech Server 105 webserver may present, at step 260, a graphical user interface in a browser for configuring the configurable objects such as, for example, the event:parameter objects discussed above. At step 265 parameters are received and stored. If the configuration interface is to configure Qtech Queue in a website to be served by the Qtech Server 105 webserver, then at step 270 the configurable webpage elements (graphics, text, etc.) for the Qtech Queue website may be presented and the configuration selections received at step 275. The process then proceeds to step 250 (discussed above).

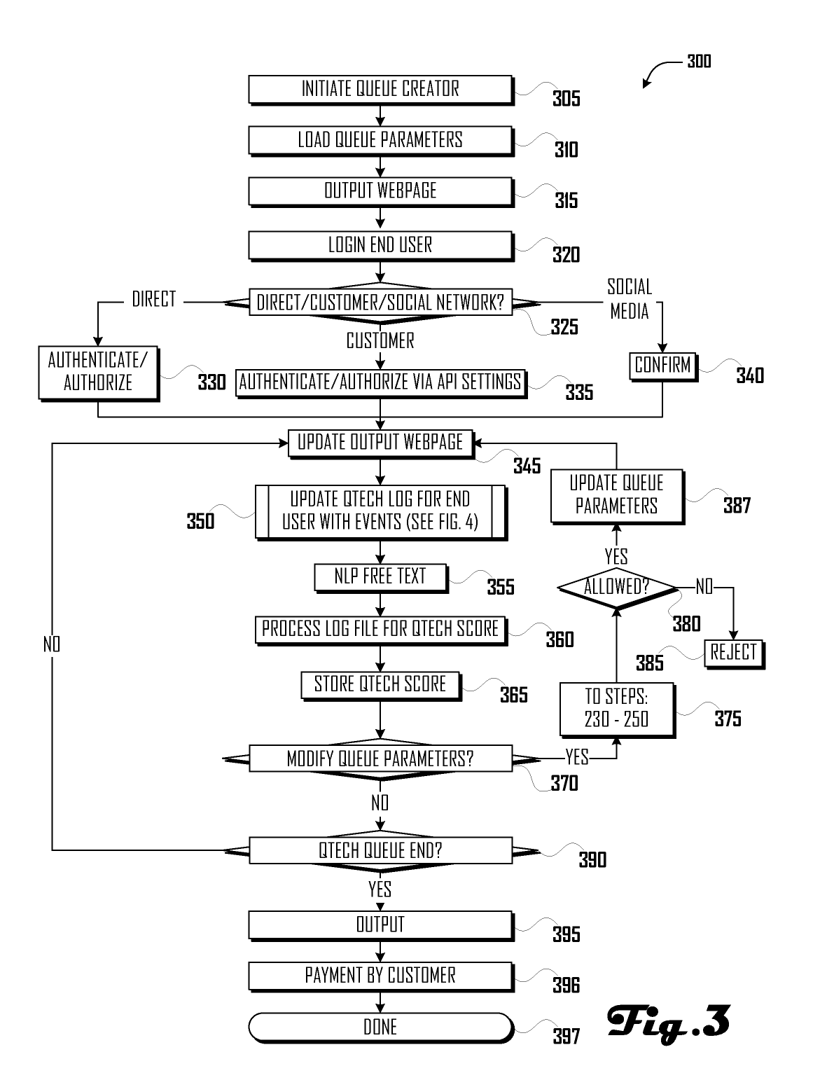

FIG. 3 is a flowchart illustrating a process in which a Qtech Queue is managed by the queue management service system according to embodiments disclosed in this paper. At step 305, a Qtech Queue creator is initiated, such as by the Qtech Server 105 executing the Qtech Server App. At step 310 the Qtech Queue creator loads the Qtech Queue object:parameters stored at step 250 for the the Qtech Queue which is to be initiated. Not shown, additional steps may be included to specify a Qtech Queue to be loaded. At step 315, a webpage corresponding to the Qtech Queue and the loaded object:parameters is output. The webpage may comprise a webpage served by the Qtech Server 105 webserver or the output may be sent to, for example, the 3^{rd} Party Server 135 where the output may be assembled into a webpage output by the 3^{rd} Party Server 135 webserver. Instead of a webpage, output may be configured to be rendered by a Qtech App (which also will be referred to for these purposes as a “webpage”). The webpage may include, for example graphics associated with the Qtech Queue, a count-down clock (if there is one) for the Qtech Queue, and text describing the goal(s) for the queue, also referred to as the “Incentives” for the Qtech Queue. At step 320, an end user logs in to the Qtech Queue webpage. At step 325, the end user may login, for example, by providing login credentials the end user may have with one or more of the Qtech Server 105 (referred to in the illustrations as “direct”), the customer (who configured the Qtech Queue per FIG. 2), or with credentials for the Social Network 145. At steps 330 and 335 the credentials may be authenticated and authorized (such as, for example, via API commands) or, per step 340, may be confirmed with the Social Network 145. At step 345, the Qtech Queue webpage is updated to reflect the successful log-in by the end user. The updated webpage may include, for example, the number of people in the Qtech Queue, the number of points the end user has relative to the Qtech Queue in question, the point rank of the end user relative to other participants in the Qtech Queue, the number of credits the end user may have in the end user's Qtech Server account (which may not be relative to the Qtech Queue in question).

Steps 315 through 345 are optional, as initiation of the Qtech Queue and logging of end user events may take place without the end users logging in to the Qtech Queue website.

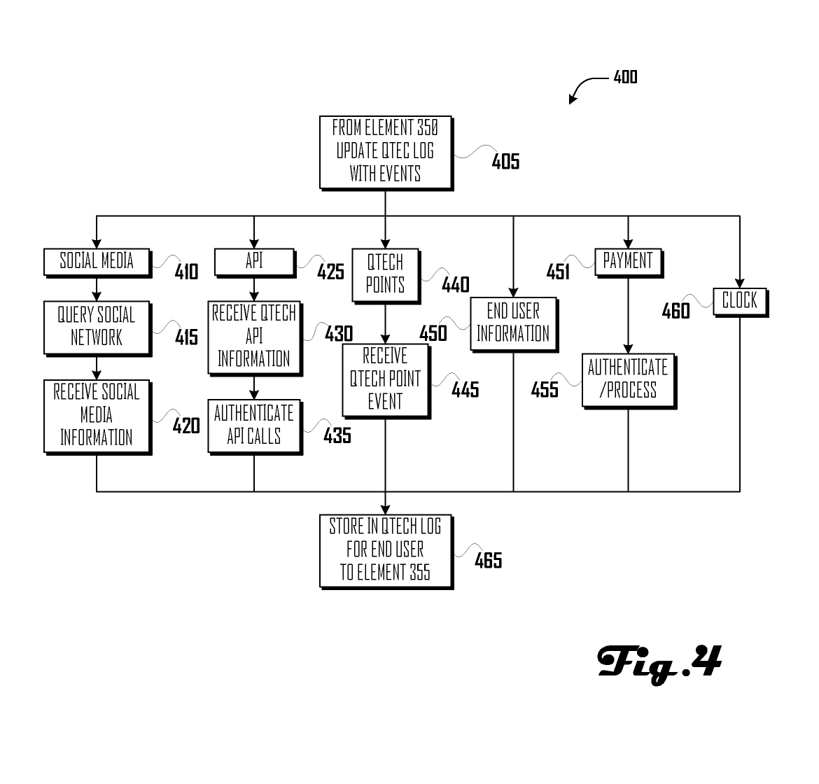

At step 350, the Qtech log for all end users in the Qtech Queue is updated to reflect end user events. Additional illustrations regarding step 350 are provided in FIG. 4 and elsewhere in this paper. As an example, the log file may be a database or plain text file and may comprise object:parameter entries (fields in a database record) such as the following: id, user_id, queue_id, queue_position_id, created_time, updated_time, activity_type, activity_score, activity_details. As an example, activity_details may be an unstructured binary large object (“blob”), in a JSON or XML format. Saving and processing the entries may be on an incremental basis (as received or in small batches) or with a full rebuild. As noted above, the activity_type entry may define functions which configure a Qtech Queue and may contain the object:parameter objects configured by the customer in steps 235 through 275. As an example, the API may accept the user_id, queue_id, activity_type, activity_details fields; all other fields may be calculated, obtained, or determined automatically.

Briefly summarizing step 350 (see also the discussion of FIG. 4), the Qtech Server 105 may monitor the Social Network 145 and otherwise may receive information (on a push or pull basis) from the devices (the End User Device 115, the Mobile End User Device 120, the 3^{rd} Party Device, and the 3^{rd} Party Server 135) regarding end user events. Monitoring the Social Network 145 may comprise providing an identifier for the end user to the Social Network in conjunction with permission to access and then being provided with information posted by the end user or associated with the end user in the Social Network. Examples of end user events include: an end user “liking,” “friending,” or “following” a product, service, company, or person, providing a positive free text review or referral of a product or service, checking into a configured device (such as at a Mobile End User Device 120 or 3^{rd} Party Device 130 via a Qtech App) at a designated location, utilizing a designated hashtag (such as in TWITTER), paying money or other consideration (such as converting Qtech points into points in a Qtech Queue), providing end user contact information, and responding to end user surveys; events may be weighted for the number of times that the event is repeated downstream by “friends” or “followers” (or similar) of the end user. At step 355, free text in end user events in the log files may be processed according to natural language processing techniques to identify free text which meets object:parameter criteria for the free text relative to the Qtech Queue, such as a positive review or reference written or provided by an end user. The object:parameter objects for free text processing may refer to established tests which identify positive, negative, and neutral free text entries (rather than having to specify parameters for the tests).

At step 360 the log files for end users in the Qtech Queue are processed to determine the scores of the end users relative to the Qtech Queue. The processed log files may be retained and added to. At step 365 the end user scores are stored, such as in the Qtech Database 110. The score may be a running total associated with the log file. Events in the log file which have been processed already may be flagged so that they are not re-processed. At step 370 a determination may be made regarding whether a Qtech Queue has been modified (whether the Attributes of the Qtech Queue have been modified), such as by changing the rules or functions according to which the log files are processed. If the determination at step 370 is yes, then at step 375, steps equivalent to steps 230 to 275 may be executed. At step 380, a determination may be made regarding whether the changes are allowed; for example, changing the goal or reward of a Qtech Queue may not be allowed, while changing the number of points awarded for “liking” a product is allowed. If the change is not allowed, then at step 385 the change may be rejected. If the change is allowed, then at step 387 the parameters for the Qtech Queue may be updated and the process may return to step 345, where the output webpage is updated.

If at step 370 there was no modification to the Qtech Queue, then at step 390 a determination may be made regarding whether the Qtech Queue has reached its specified end. The end may be determined by, for example, a chronological event, such as a date or time or an interval of time, on the number of end users in the Qtech Queue, on points earned by end users, on end user events, or on a price bid in relation to a product or service (including on a product or service which is the goal or reward of the Qtech Queue).

At step 395, the output of the Qtech Queue may be determined and implemented. For example, the end user scores may be ranked and first 100 people (by rank) in the Qtech Queue at the conclusion may be awarded a product or service at a first price, while the remaining people in the Qtech Queue may be awarded the same or a different product or service at a second price, end users of a certain rank may be awarded a coupon or discount, end users may be awarded Qtech points (relative to their Qtech account, not relative to the Qtech Queue in questions), loyalty reward points or other consideration may be awarded to end users of a certain rank (in loyalty programs maintained by the customer or by the provider), tickets to exclusive launch events and experiences may be provided to end users of a certain rank, product samples may be provided to end users of a certain rank, end users of a certain rank may advance to another Qtech Queue, end users of a certain rank may be given priority in placing product pre-orders, and information regarding the end users in the Qtech Queue may be provided to the customer. The determination of the output will generally be established during configuration of the Qtech Queue, per FIG. 2 (during establishment of the Attributes of the Qtech Queue), or during the modify queue routine discussed above in relation to step 370. The output of the Qtech Queue may also be referred to as the “Incentives” which the Qtech Queue offers.

At step 396 the customer may pay consideration to the Qtech Server 105 operator, if payment was not already received. Payment may be based, for example, on information regarding the end users in the Qtech Queue provided to the customer in step 396, on a flat rate, on a percentage of the amount of goods or services sold in the Qtech Queue, on a dollar equivalent of loyalty reward points earned by end users, or based on other criteria. At step 397 the process concludes.

FIG. 4 is a flowchart illustrating details of alternative embodiments for a portion of the flowchart illustrated in FIG. 3. Step 405 shows additional steps which may take place in element 340 in FIG. 3. At step 410 social media events are obtained, for example, by querying the Social Network 145 and/or by providing the Social Network 145 with identifiers for end users and indications of consent by such end users to have end user information in the Social Network 145 sent to or accessed by the Qtech Server 105. At step 420 the end user information is received from the Social Network 145, whether in a push (where the information is sent to the Qtech Server 105 by the Social Network 145) or pull (where the information is queried for by the Qtech Server 105) process. The information received from the Social Network 145 may include information not relevant to the Qtech Queue; a filtering step, not shown, may discard information which is not flagged as relating to an end user event. Alternatively, all the information from the Social Network 145 may be retained. At step 465 the end user events are stored in the logs corresponding to the end users.

At step 425, end user event information is received via the API. For example, a 3^{rd} Party Device 130 or 3^{rd} Party Server 135 may be present at a venue, such as a store or a music concert. The Device or Server may be configured to collect end user identifiers and/or to send event information to the Qtech Server 105. For example, end users may become physically proximate to the 3^{rd} Party Device 130 and hit a button or other graphical object on their own Mobile End User Device 120, which communicates the identity of the end user to the 3^{rd} Party Device 130; alternatively, the end user may input a code into the the 3^{rd} Party Device 130, may login to the 3^{rd} Party Device 130, may present a barcode or similar to the 3^{rd} Party Device 130, or may have their picture taken by the 3^{rd} Party Device 130, with optical recognition being performed on the picture to identify the end user; alternatively, the 3^{rd} Party Server 135 may be a point-of-sale system which reports event information to the Qtech Server 105. A Qtech App executed by the 3^{rd} Party Device 130 or Server 135 may be configured to associate the end user identity with an event programmed by the customer and may communicate, via the API, the end user identity/event association to the Qtech Server 105. The foregoing process may take place entirely through the Mobile End User Device 120, without the 3^{rd} Party Device 130, with the location of the end user and the time the end use was at the location being provided by the End User Device 120 (such as by GPS components in the End User Device 120), which location and time may be enough to associate the end user with the event programmed by the customer. The process then proceeds to step 465, discussed above.

At step 440, Qtech points may be converted by the end user into points in a Qtech Queue. Conversion may be accomplished, for example, through the Qtech Queue website or through an appropriately configured End User Device executing a Qtech Application. At step 445 the Qtech point event is received and authenticated and authorized. The process then proceeds to step 465, discussed above.

At step 450 end user information may be received along with consent to use the end user information to contact the end user. Alternatively, this element may represent receiving end user information in the course of a survey or questionnaire. Receipt of such information (and optional consent) may entitle the end user to Qtech points relative to a Qtech Queue or relative to the end user's account with Qtech Server 105. The process then proceeds to step 465, discussed above.

At step 451 payment may be received from an end user. Payment may entitle the end user to points in a Qtech Queue. At step 455 the payment may be authenticated and processed. Either the amount of the payment or the corresponding number of points may be recorded in the end user log. The process then proceeds to step 465, discussed above.

At step 460 the passage of time may be an event which is recorded in the end user log. The process then proceeds to step 465, discussed above.

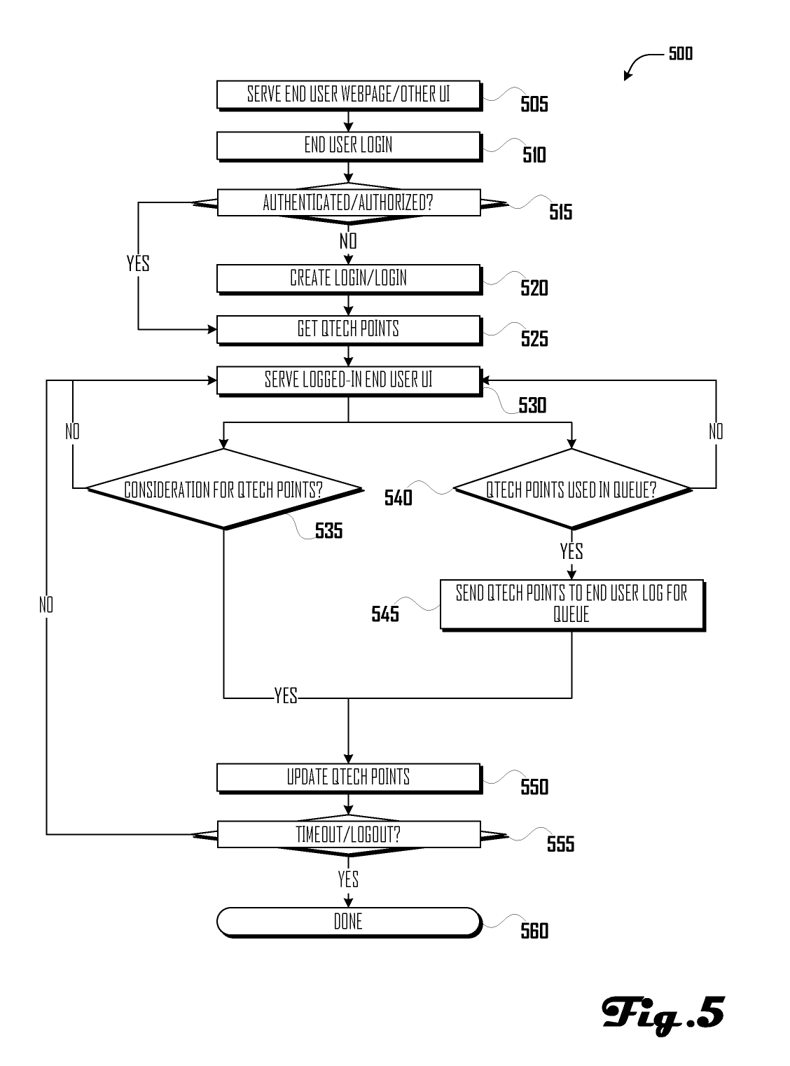

FIG. 5 is a flowchart illustrating a process in which a queue participant or end user interacts with the queue management service system according to embodiments disclosed in this paper. In this interaction, the end user may purchase Qtech points apart from a Qtech Queue and the end user may send Qtech points to a Qtech Queue. At step 505 the Qtech Server 105 serves the end user a webpage or another user interface (such as data interpreted by a Qtech app). At step 510 the end user logs into the Qtech Server 105. If not authenticated or authorized at step 515, then at step 520 the end user may create a login and may log into the Qtech Server 105. Following either step 520 or 515, the Qtech Server 105 obtains the Qtech points associated with the end user. At step 530 the Qtech Server 105 serves a user interface for the logged-in end user. At step 535 a determination may be made regarding whether the end user is paying consideration for Qtech points. As discussed elsewhere, the consideration may take the form of money, of contact information for the end user (with optional consent to contact the end user), or of responses to a survery. If consideration is received (and processed, not shown), then at step 550 the Qtech points for the end user may be updated. The Qtech points may be associated with the end user in general (via the end user's account with the Qtech Server 105), not with a specific Qtech Queue.

Step 540 illustrates a decision which may be made regarding whether the end user is directing that Qtech points be allocated to a Qtech Queue. If they are, then at step 545, the Qtech points may be deducted from the end user's account and a corresponding log entry is noted in the end user log for the Qtech Queue in question. At step 550 the Qtech points for the end user may be updated. At step 555 a determination may be made regarding whether a timeout event has occurred or if the end user has logged out. If yes, then at step 560, the process may end. If at steps 535 or 540 the determination is no, then the process may return to step 530, discussed above. Step 530 may proceed to step 555 without the intervening steps of 535 to 545.

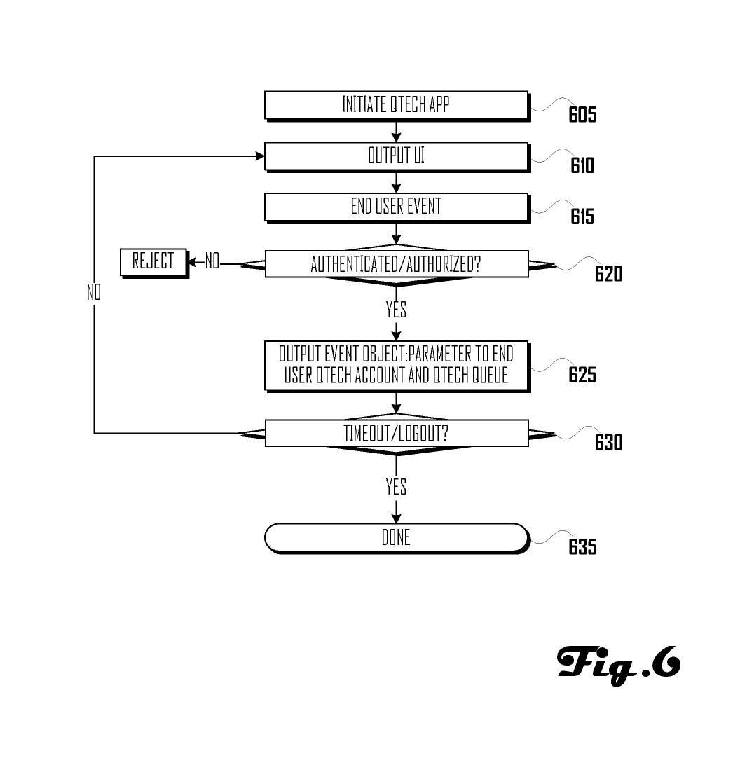

FIG. 6 is a flowchart illustrating a process in which a queue participant or end user interacts with the queue management service system via a mobile device according to embodiments disclosed in this paper. This illustration may be considered as a variation of or further information regarding the process discussed above in relation to elements 425 through 435. At step 605, execution of a Qtech Application is initiated, for example, in an End User Device 115, a Mobile End User Device 120, or a 3^{rd} Party Device 130. At step 610 the user interface for the Qtech Application is output (which may be to a browser). At step 615 an end user event relating to a Qtech Queue may occur. See the discussion above relating to elements 425 through 435 for an example of end user events which are communicated to the Qtech Server 105 via API commands, potentially via a Qtech Application—the Qtech Application may, though need not, communicate the occurrence of the event through the API. At step 620 the end user event may be authenticated and authorized. At step 625 the event object:parameter may be output to the end user log for the Qtech Queue and/or to the Qtech account to which the event relates. At step 630 a timeout/logout decision may be made. At step 635 the process may conclude.

Steps in this process which involve payment, whether by or to an end user (such as for the purchase of Qtech Points, for the purchase of products or services (which may be events in Qtech Queues), or for the payment to an end user for a cash or loyalty reward payment) or by or to customers (such as for the creation of a Qtech Queue or implementation of the output of a Qtech Queue) may utilize e-commerce platforms (such as provided by Shopify, BigCommerce, Magento, Demandware and others). Such utilization may be through use of such parties' APIs and extensions or through customized integration with such parties' systems.

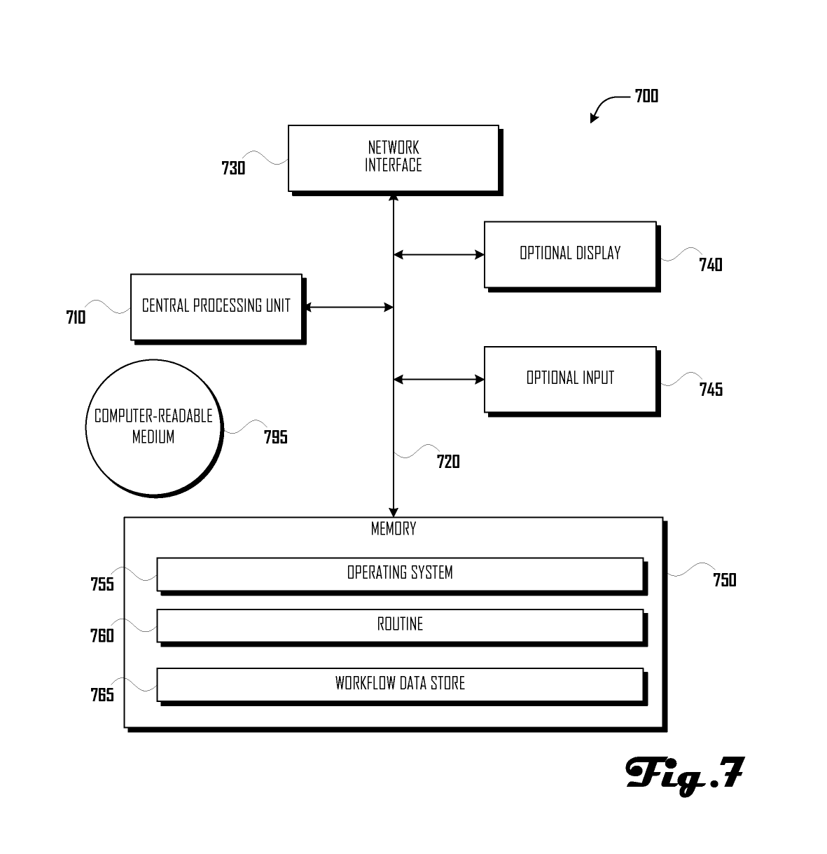

FIG. 7 is a functional block diagram of exemplary computing devices and some data structures and/or components thereof, such as the computing devices shown in FIG. 1. In some embodiments, the computing device 700 may include many more components than those shown in FIG. 7. However, it is not necessary that all of these generally conventional components be shown in order to disclose an illustrative embodiment. As shown in FIG. 7, the computing device 700 includes a network interface 730 for connecting to the network 125.

The computing device 700 also includes at least one processing unit 710, memory 750, and an optional display 740, all interconnected along with the network interface 730 via a bus 720. The memory 750 generally comprises a random access memory (“RAM”), a read only memory (“ROM”), and a permanent mass storage device, such as a disk drive or SDRAM (synchronous dynamic random-access memory). The memory 750 stores program code for routines 760, such as, for example, the Qtech App, as well as web browsing applications, web serving applications, and database applications. In addition, the memory 750 also stores an operating system 755. These software components may be loaded from a non-transient computer readable storage medium 795 into memory 750 of the computing device 700 using a drive mechanism (not shown) associated with a non-transient computer readable storage medium 795, such as a floppy disc, tape, DVD/CD-ROM drive, memory card, or other like storage medium. In some embodiments, software components may also or instead be loaded via a mechanism other than a drive mechanism and computer readable storage medium 795 (e.g., via network interface 730).

The computing device 700 may also comprise hardware supporting optional input modalities, Optional Input 745, such as, for example, a touchscreen, a keyboard, a mouse, a trackball, a stylus, a microphone, and a camera.

Computing device 700 also comprises or communicates via bus 720 with workflow data store 765. In various embodiments, bus 720 may comprise a storage area network (“SAN”), a high speed serial bus, and/or via other suitable communication technology. In some embodiments, computing device 700 may communicate with workflow data store 765 via network interface 730.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of managing a virtual dynamic advancement queue in a computer comprising a memory, comprising:
defining a first queue according to parameters received from a first queue creator, which first queue assigns points to queue participants upon the occurrence of events according to the parameters;
initiating the first queue and logging at least a first and a second queue participant into the first queue following on a queue entry event, which queue entry event comprises at least one of purchase of a product, arrival at a location, and providing an email address;
logging events in an event log, which events comprise at least one of the passage of a period of time, a queue participant posting information to a social media network, a third party re-transmitting information posted to the social media network by the queue participant, a queue participant purchasing points, referring another party to enter the queue, providing information to a questionnaire, and a queue participant checking in at a location;
processing the event log to determine the points of at least the first and second queue participants;
determining that the first queue has ended; then
ranking the first and second queue participants according to points; and
receiving consideration from the first queue creator.
